(19) United States
(12) Patent Application Publication
(10) Pub. No.: US 2023/0017762 A1
(43) Pub. Date: Jan. 19, 2023

(54) SPINAL TRACTION DEVICE

(71) Applicant: Rafael Flores, Charleston, SC (US)

(72) Inventor: Rafael Flores, Charleston, SC (US)

(21) Appl. No.: 17/375,316

(22) Filed: Jul. 14, 2021

(51) Int. Cl. A61H 1/02

(52) U.S. Cl. CPC A61H 1/0222; A61H 2201/1215; A61H 2201/1626; A61H 2201/1664

(57) ABSTRACT

A platform for providing spinal traction. Separate planar members having a generally flat and horizontal surface provide a platform for a user, who positions himself or herself in a supine position on a first planar member and a second planar member that form the platform. The first planar member has spaced apart vertical members that engage the user's underarms. The second planar member comprises a restraining member that surrounds the user at approximately the waist of the user. A drive apparatus allows the user to selectively and progressively separate the first planar member from the second planar member so that the vertical members pull the upper torso away from the lower portion of the person's body that is held in position relative to the second planar member by the restraining member.

### BACKGROUND OF THE INVENTION

Spinal traction stretches the spine to relieve pressure from compressed discs. Discs may become compressed from the effects of gravity or due to trauma. Traction can straighten the spine to relieve back pain and promote healing. Spinal traction may improve or correct slip discs, herniated discs, sciatica, and stenosis.

### SUMMARY OF THE INVENTION

The present invention is a platform for spinal traction. Separate planar members having a generally flat and horizontal surface provide a platform for a user, who positions himself or herself in a supine position on a first planar member and a second planar member that form the platform. The first planar member has spaced apart vertical members that engage the user's underarms. The second planar member comprises a restraining member that surrounds the user at approximately the waist of the user. A drive apparatus allows the user to selectively and progressively separate the first planar member from the second planar member so that the vertical members pull the upper torso away from the lower portion of the person's body that is held in position relative to the second planar member by the restraining member.

### BRIEF DRAWING DESCRIPTION

FIG. 1 is a perspective view of the platform for spinal traction according to an embodiment of the invention.

FIG. 2 is a perspective view of the platform for spinal traction, demonstrating the first planar member separating from the second planar member.

FIG. 3 is a perspective view of the platform for spinal traction demonstrating a user (by broken lines) positioned on the in the supine position.

FIG. 4 is view of an embodiment of a mechanism for separating the first platform from the second platform.

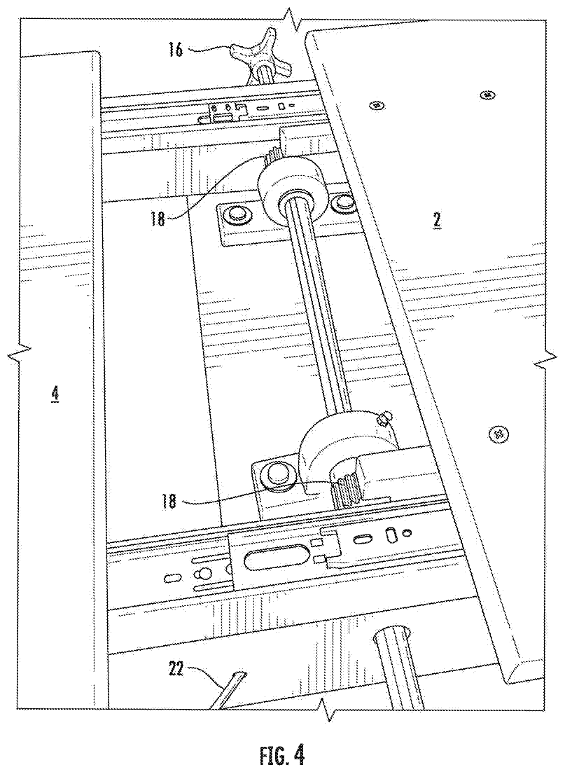

### DESCRIPTION OF PREFERRED EMBODIMENTS

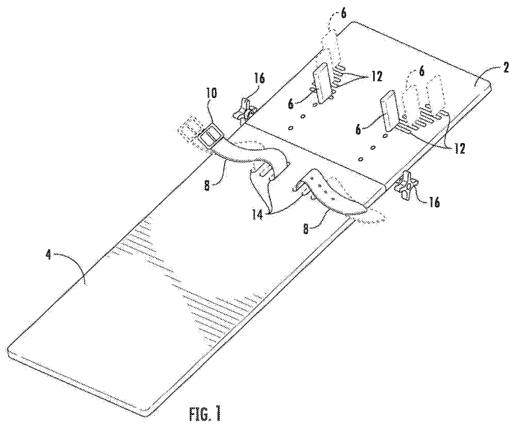

As shown in FIG. 1, the platform for spinal traction according to a preferred embodiment of the invention is comprised of two (2) planar members. A first planar 2 member is shown in FIG. 1 near the top and right of FIG. 1. The second planar member 4 is shown in the lower portion and to the left of FIG. 1. The length of the device, as the term is used herein, is the dimension that accommodates the height and length of the user. The length of the device and, therefore, the length of each planar member runs from the lower left hand corner of FIG. 1 to the upper right hand side of FIG. 1, when FIG. 1 is viewed in landscape.

The first planar member 2 and the second planar member 4 in this embodiment have a generally flat top surface that, in use, is positioned generally horizontally. The platform for spinal traction may be elevated, by providing legs or similar support structures for the platform for spinal traction. Legs or other elevating support structures are not shown in the drawings.

The top surface of the platform could have other contours as long as the user can position himself or herself in a supine position, although some degree of inversion of the user while using the device could be beneficial for stretching the spine. Inversion may be accomplished by elevating the end of the second planar member 4 that is opposite the first planar member 2 relative to the remainder of the platform.

As shown in FIG. 1, the first planar member 2 comprises a series of slots 12 that extend along the first planar member. A plurality of slots is formed on the left side of the first planar member and a series of slots is formed on the right side of the first planar member. The series of slots allow horizontal and vertical positioning of vertical members 6 that extend upwardly from the first planar member.

The generally vertical members 6 are positioned in the underarm space of the user and hold the upper torso of the user in position on the first planar member 2. The vertical members are selectively positioned within the plurality of slots 12 according to the user's height, and according to the distance between the user's left underarm and right underarm. In a preferred embodiment, at least three slots are preferred to be present on each side of the first planar member. As shown in the drawing figures, six slots are present on each side of the first planar member, and more slots may be provided. The slots as shown are generally parallel to the width of the first planar member.

The second planar member 4 comprises a series of slots 14 that extend across the second planar member. A plurality of slots is present on the left side of the second planar member and a plurality of slots is present on the right side of the second planar member.

It is preferred that at least three slots 14 is provided on the left side of the second planar member 4, and at least three slots are present on the opposite side of the second planar member, although additional slots may be provided. The slots are positioned approximately where the waist of the user is positioned while lying on the platform for spinal traction during use. The slots as shown are positioned generally parallel to the length of the second planar member.

A restraining member 8 is looped through two of the slots 14 as shown in the preferred embodiment, with the restraining member extending through one slot on the left side of the second planar member 4, and an opposite end of the restraining member extending through a slot on the right side of the second planar member.

An attachment device 10 is provided to connect the first end of the restraining member 8 with the opposite end of the restraining member when the user is in position for use. The attachment device may be a buckle, as shown in the drawings, or it may comprise hook and loop material or other means for attaching ends of belts or similar restraining members.

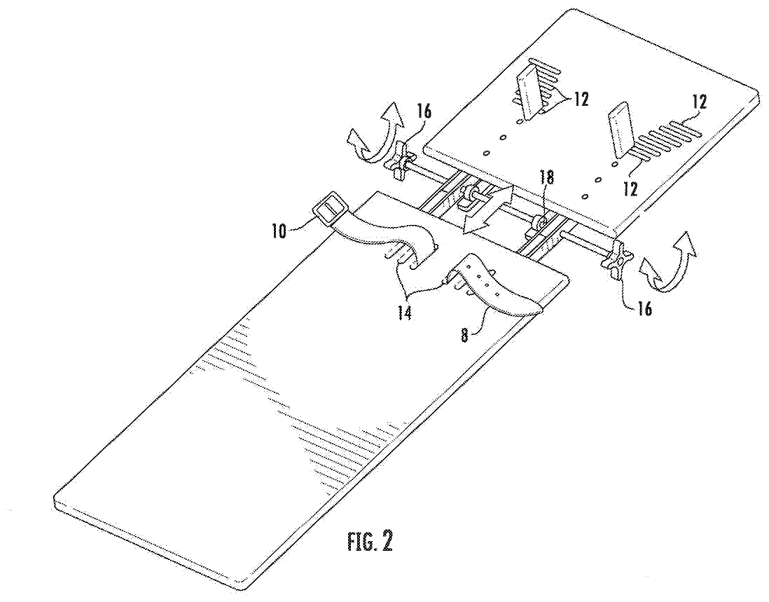

Also provided is one or more rotatable members 16 positioned to a side of the platform and in one embodiment approximately between an end of the first planar and an end of the second planar member The rotatable member allows the user to incrementally separate the first planar member 2 from the second planar member 4. FIG. 2. In the embodiment shown, the rotatable member rotates a gear or gears 18 in a rack and pinion structure to push the first planar member away from the second planar member. A pawl may be incorporated into the rack and pinion structure to prevent the first planar member 2 from moving back toward the second planar member 4 as the first planar member is advanced away from the second planar member. The rack and pinion system with pawl allows the user to move the first planar member slowly and incrementally away from the second planar member, moving the rotatable member to advance one gear tooth at a time. Slow advancement allows the user to maintain the comfort as the first planar member moves away from the second planar member. As the spine stretches, the user may continue to advance the first planar member away from the second planar member while maintaining the comfort of the user. The pawl may be released by the user by applying a force to lever 22. The device may then be moved back to its original position as shown in FIG. 1.

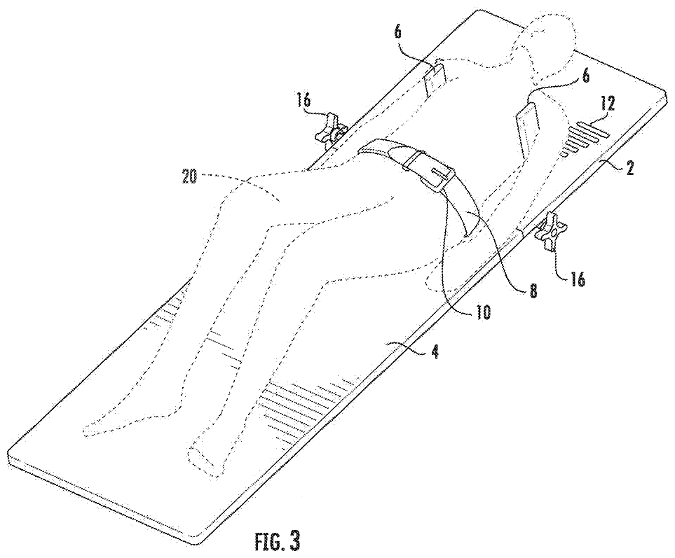

FIG. 3 shows the platform for spinal traction with a user 20 in position. The spaced apart vertical members 6 are positioned at the underarms of the user. The spaced apart vertical members extend generally upwardly, and the particular slots 12 and positioning within the slots are chosen according to the distance between the underarms of the user and the height of the user. The taller the user, the more the generally vertical members are moved toward the top of the first planar member. The wider the distance between the underarms of the user, the more the generally vertical members are positioned toward the outside edges of the first planar member. While the generally vertical members are shown in the lower slots in FIG. 3, FIG. 1 demonstrates how the generally vertical members can be moved upwardly for taller users and outwardly for users having a wider space between the underarms.

The first planar member 2 abuts or is in very close proximity to the second planar member 4 prior to use. A user 20 is positioned lying supine on the platform. The restraining member 8 is positioned about the waist of the user. The belt is sufficiently tightened so that the user's lower body is held generally static and in position on the second planar member. That is, the user's lower body should be held in place relative to the second planar member as the first planar member is moved away from the second planar member.

After the user 20 is positioned on the platform for spinal traction, with the restraining member 8 tightened, the rotatable member 16 is rotated, causing the first planar member 2 to move away from the second planar member 4, as shown in FIG. 2. The restraining member holds the lower portion of the user's body in position relative to the second planar member, while the spaced apart vertical members pull the upper portion of the user's body away from the lower portion of the user's body as the first planar member and second planar member separate. Pulling the upper portion of the user's body from the lower portion of the user's body provides spinal traction that stretches the spine and takes pressure off of compressed discs.

The preferred invention as described herein uses a rack and pinion structure as a drive apparatus for advancing the first planar member away from the second planar member. However, other mechanisms could be used, including an electric motor that creates rotation of the gear for the rack and pinion structure. In use, a motorized version is preferred to have a control mechanism so that the first planar member and second planar member advance slowly, with a provision for the user to quickly terminate separation so that the user does not experience discomfort or dangerous stretching of the spine and torso.

What is claimed:

1. A platform for spinal traction, comprising:
a first planar member, the first planar member comprising spaced apart vertical members, constructed and arranged to engage a user's underarms;
a second planar member, the second planar member having a length that exceeds a length and width of the first planar member and a retaining member constructed and arranged to surround a waist of a user;
a drive apparatus comprising a rotatable member and a gear that engages the first planar member, and upon rotation of the rotatable member, pushes the first planar member away from the second planar member.

2. A platform for spinal traction as described in claim 1, wherein the first planar member comprises a plurality of generally parallel slots that extend along a length of the first planar member.

3. A platform for spinal traction as described in claim 1, wherein the second planar member comprises a plurality of generally parallel slots extending across a width of the second planar member.

4. A platform for spinal traction as described in claim 1, wherein the second planar member comprises a plurality of generally parallel slots extending across a width of the second planar member, and the retaining member is selectively positioned within two the slots of the plurality of slots to retain a user according to a user's girth.

5. A platform for spinal traction as described in claim 1, wherein the retaining member is a belt comprising a first end, a second end and an attachment device that connects the first end of the retaining member to the second end of the retaining member.

6. A platform for spinal traction as described in claim 1, wherein the second planar member comprises three generally parallel slots extending across a first side of the second planar member, and further comprises three generally parallel slots extending across an opposite side of the second planar member, and one end of the retaining member extends from a selected slot of the generally parallel slots extending across a first side of the second planar member and an opposite end of the retaining member extends from a selected slot of the generally parallel slots extending across the opposite side of the second planar member, and wherein a slot from which the one end of retaining member extends and the slot from which the opposite end of the retaining member extends is selected according to a user's girth.

7. A platform for spinal traction as described in claim 1, wherein the first planar member comprises three generally parallel slots extending along a first side of the first planar member, and further comprises three generally parallel slots extending along an opposite side of the first planar member, and one of the spaced apart vertical members extends upwardly from a selected slot of the generally parallel slots extending along the first side of the first planar member and an opposite spaced apart vertical member extends upwardly from a selected slot of the three generally parallel slots extending along the opposite side of the first planar member, and wherein the selected slot from which the one of the vertical members extends upwardly and the selected slot from which the opposite spaced apart vertical member extends upwardly is selected according to a user's height.

8. A platform for spinal traction as described in claim 1, wherein the second planar member comprises three generally parallel slots extending across a first side of the second planar member, and further comprises three generally parallel slots extending across an opposite side of the second planar member, and one end of the retaining member extends from a selected slot of the generally parallel slots extending across a first side of the second planar member and an opposite end of the retaining member extends from a selected slot of the generally parallel slots extending across the opposite side of the second planar member, and wherein a slot from which the one end of retaining member extends and the slot from which the opposite end of the retaining member extends is selected according to a user's girth; and wherein the first planar member comprises three generally parallel slots extending along a first side of the first planar member, and further comprises three generally parallel slots extending along an opposite side of the first planar member, and one of the spaced apart vertical members extends upwardly from a selected slot of the generally parallel slots extending along the first side of the first planar member and an opposite spaced apart vertical member extends upwardly from a selected slot of the three generally parallel slots extending along the opposite side of the first planar member, and wherein the selected slot from which the one of the vertical members extends upwardly and the selected slot from which the opposite spaced apart vertical member extends upwardly is selected according to a user's height.

9. A platform for spinal traction as described in claim 1, wherein the gear of the rotatable member engages a pawl.
